(19) United States
(12) Patent Application Publication
(10) Pub. No.: US 2025/0385337 A1
(43) Pub. Date: Dec. 18, 2025

(54) BATTERY MODULE AND BATTERY PACK INCLUDING THE SAME

(71) Applicants: HYUNDAI MOTOR COMPANY, Seoul (KR); KIA CORPORATION, Seoul (KR)

(72) Inventors: Gyung Hoon Shin, Hwaseong-si (KR); Hae Woong Jung, Hwaseong-si (KR)

(73) Assignees: HYUNDAI MOTOR COMPANY, Seoul (KR); KIA CORPORATION, Seoul (KR)

(21) Appl. No.: 19/187,252

(22) Filed: Apr. 23, 2025

(30) Foreign Application Priority Data
Jun. 12, 2024 (KR) 10-2024-0076566
Feb. 11, 2025 (KR) 10-2025-0017452

(51) Int. Cl. H01M 10/6551; H01M 10/613; H01M 10/647; H01M 10/656; H01M 50/211; H01M 50/271; H01M 50/289

(52) U.S. Cl. CPC H01M 10/6551; H01M 10/613; H01M 10/647; H01M 10/656; H01M 50/211; H01M 50/271; H01M 50/289

(57) ABSTRACT

A battery module is disclosed. The battery module includes a battery stack including a plurality of battery cells stacked in a first direction, one or more pad members provided between the plurality of battery cells, and a heat transfer member. The heat transfer member is provided at one side of the battery stack and provided to be in contact with the battery stack. The plurality of battery cells extend in a second direction intersecting the first direction. The heat transfer member is provided at one side of the battery stack in a third direction intersecting the first and second directions. The heat transfer member includes first and second heat transfer members provided in the form of different materials.

### CROSS-REFERENCE TO RELATED APPLICATIONS

This application claims priority to and the benefit of Korean Patent Application No. 10-2024-0076566 filed in the Korean Intellectual Property Office on Jun. 12, 2024, and No. 10-2025-0017452 filed in the Korean Intellectual Property Office on Feb. 11, 2025, the entire contents of which are incorporated herein by reference.

### TECHNICAL FIELD

The present disclosure relates to a battery module and a battery pack including the same.

### BACKGROUND

In order to satisfy the marketability of battery modules mounted in electric vehicles, battery modules should charge sufficiently with electrical energy in a short (e.g., reduced) amount of time. Further, it is useful for the battery to have a temperature within an appropriate range during an operating process of the battery module. To this end, it is useful to provide a heat dissipation structure capable of (e.g., effectively) dissipating heat, which is generated in the battery module, to the outside.

As the market for high-performance electric vehicles expands, studies to maximize the performance of the battery pack by improving methods of stacking the battery modules may be useful. Further, it may be useful to review the increased amount of heat generated in the battery pack, as it is challenging to (e.g., effectively) dissipate heat generated in the high-performance battery pack.

### SUMMARY

The present disclosure is directed to improve dissipation of heat generated in a battery module.

An aspect of the present disclosure provides a battery module including a battery stack including a plurality of battery cells stacked in a first direction D1, and one or more pad members provided between the plurality of battery cells, and a heat transfer member provided at one side of the battery stack and provided to be in contact with the battery stack, in which the plurality of battery cells extend in a second direction D2 intersecting the first direction D1, in which the heat transfer member is provided at one side of the battery stack in a third direction D3 intersecting the first and second directions D1 and D2, and in which the heat transfer member includes first and second heat transfer members made of different materials.

The first heat transfer member and the second heat transfer member may (e.g., each) contain a curable material.

Fluidity of the first heat transfer member measured before the first heat transfer member is cured may be lower than fluidity of the second heat transfer member measured before the second heat transfer member is cured.

The first heat transfer member may be applied to a peripheral region of the second heat transfer member.

The first heat transfer member may be applied to a peripheral region at one side of the second heat transfer member in the second direction D2.

A maximum length of the first heat transfer member in the first direction D1 may be shorter than a maximum length of the second heat transfer member in the first direction D1.

The heat transfer members may be respectively provided at two opposite sides of the battery stack in the third direction D3.

Each of the plurality of battery cells may include a pouch-type exterior material having an internal space, and an electrode stack accommodated in the internal space. The pouch-type exterior material may include a pouch body region configured to define the internal space, and a sealing region formed by attaching partial regions of the pouch-type exterior material and provided to surround a periphery of the pouch body region. The sealing region may include a first sealing region formed at one side of the pouch-type exterior material in the third direction D3, and the first sealing region may be provided to be in contact with the heat transfer member.

The first sealing region may be provided to be in contact with the first heat transfer member and the second heat transfer member.

The sealing region may further include second sealing regions connected to one side end of the first sealing region in the second direction D2 and protruding in the second direction D2, and a bat ear section, which protrudes from the pouch body region in the third direction D3, may be provided at one side end of the second sealing region in a direction of the third direction D3 away from the first sealing region.

The second sealing regions may be provided at two opposite side ends of the first sealing region in the second direction D2, and the heat transfer member may be in contact with one side surface of the pouch body region in the third direction D3 and provided inward of the bat ear section in the second direction D2.

The first sealing region may have a bent section bent in a direction intersecting the third direction D3, and the bent section may be in contact with the heat transfer member.

The battery module may further include a holder member provided at one side of the battery stack in the second direction D2, in which a partial region of the holder member is provided to cover one side of the battery stack in the third direction D3, and in which the heat transfer member is provided to face, in the second direction D2, a portion of the holder member that covers one side of the battery stack in the third direction D3.

A maximum length in the third direction D3 of an outermost side pad member, which is provided at an outermost side in the first direction D1 among the pad members provided in the battery stack, may be longer than a maximum length in the third direction D3 of another pad member adjacent to the outermost side pad member.

The battery module may further include side plates respectively provided at two opposite sides of the battery stack in the first direction D1, and a strip member having one side coupled to the side plate provided at one of the two opposite sides of the battery stack, and the other side coupled to the side plate provided at the other of the two opposite sides of the battery stack, in which the outermost side pad member includes a pad recess region formed at one side end of the outermost side pad member in the third direction D3 and having a shape recessed in the third direction D3, and in which the strip member is seated in the pad recess region.

The heat transfer member may be provided to face the battery stack in the third direction D3 with the strip member interposed therebetween, and a region of the second heat transfer member, which overlaps the strip member, may protrude further outward in the first direction D1 than a region of the second heat transfer member spaced apart from the strip member in the second direction D2.

Another aspect of the present disclosure provides a battery pack including the battery module, and a cooling pipe provided at one side of the battery module in the third direction D3. The heat transfer member includes a lower heat transfer member provided between the battery stack and the cooling pipe, and an upper heat transfer member provided to face the lower heat transfer member with the battery stack interposed therebetween.

The upper heat transfer member may be fixedly coupled to the battery stack, and the lower heat transfer member may be fixedly coupled to the cooling pipe.

The lower heat transfer member and the upper heat transfer member may each include the first heat transfer member and the second heat transfer member. A width and a position in the first direction D1 and the second direction D2 of the first heat transfer member of the upper heat transfer member may correspond to a width and a position in the first direction D1 and the second direction D2 of the first heat transfer member of the lower heat transfer member. A width and a position in the first direction D1 and the second direction D2 of the second heat transfer member of the upper heat transfer member may correspond to a width and a position in the first direction D1 and the second direction D2 of the second heat transfer member of the lower heat transfer member.

According to the present disclosure, it is possible to (e.g., more effectively) dissipate heat generated in the battery module.

### BRIEF DESCRIPTION OF THE DRAWINGS

FIG. 1 is a first perspective view illustrating a battery module according to the present disclosure.

FIG. 2 is a second perspective view illustrating the battery module according to the present disclosure.

FIG. 3 is an enlarged view illustrating a strip member of the battery module according to the present disclosure and surrounding components thereof.

FIG. 4 is a view illustrating a state in which a heat transfer member in FIG. 3 is removed.

FIG. 5 is a side view of a battery cell provided in the battery module according to the present disclosure.

FIG. 6 is an enlarged view illustrating a bent section formed in a first sealing region of the battery cell in FIG. 5.

FIG. 7 is an enlarged view illustrating a bat ear section formed in a second sealing region of the battery cell in FIG. 5.

FIG. 8 is a vertical cross-sectional view of the battery module according to the present disclosure.

FIG. 9 is an enlarged view illustrating a holder member of the battery module according to the present disclosure and surrounding components thereof.

FIG. 10 is a view illustrating a state in which the holder member in FIG. 9 is removed.

FIG. 11 is a cross-sectional view illustrating a battery pack according to the present disclosure.

### DETAILED DESCRIPTION

Hereinafter, a battery module and a battery pack according to the present disclosure will be described with reference to the drawings.

### Battery Module

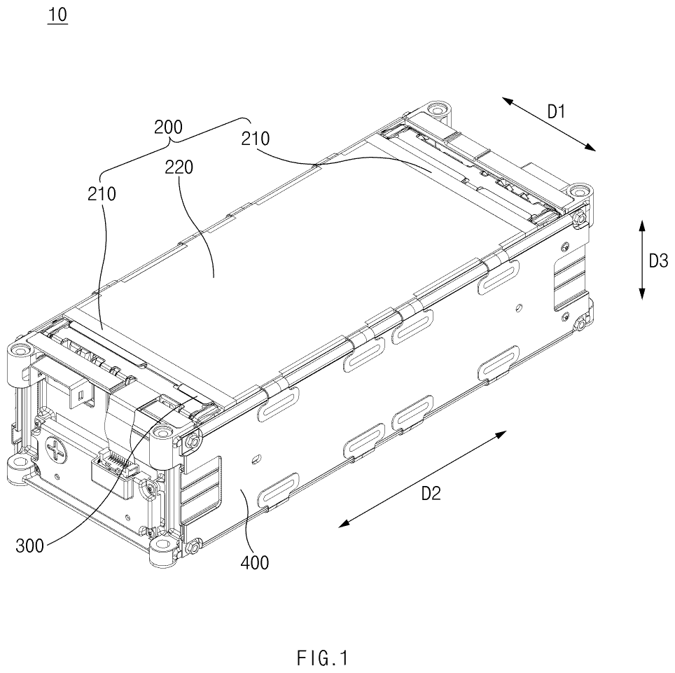

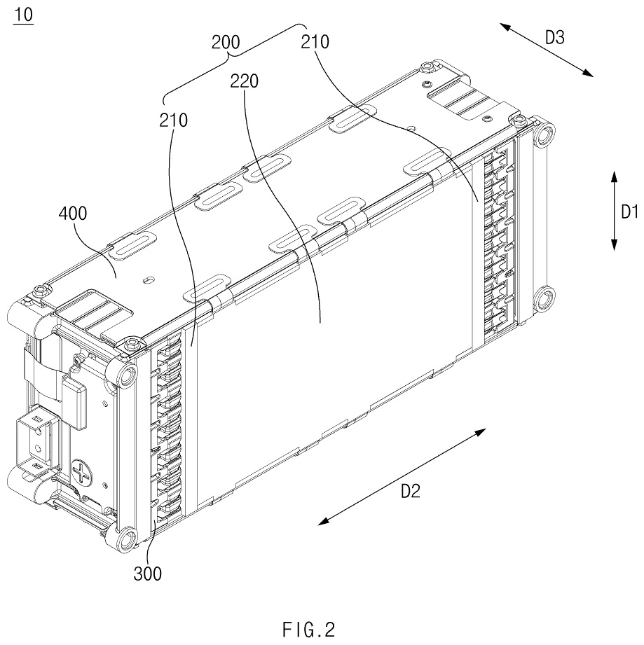

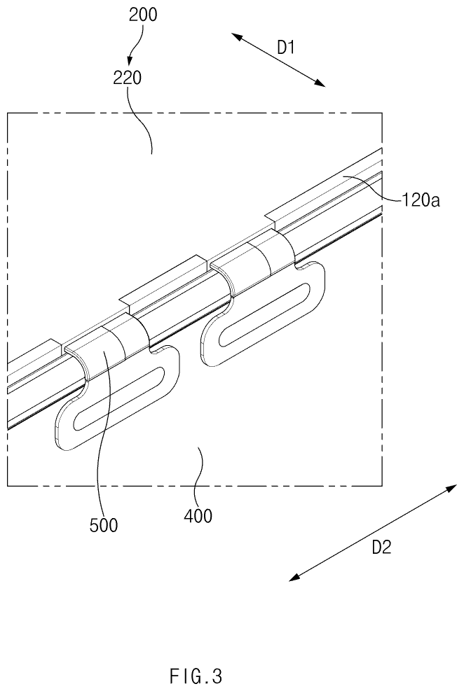

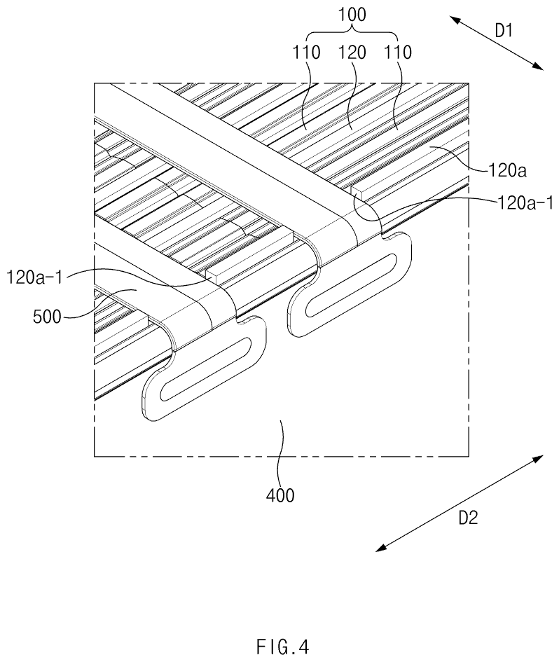

FIG. 1 is a first perspective view illustrating a battery module according to the present disclosure, and FIG. 2 is a second perspective view illustrating the battery module according to the present disclosure. FIG. 3 is an enlarged view illustrating a strip member of the battery module according to the present disclosure and surrounding components thereof, and FIG. 4 is a view illustrating a state in which a heat transfer member in FIG. 3 is removed.

With reference to FIGS. 1 to 4, a battery module 10 according to the present disclosure may include a battery stack 100 including a plurality of battery cells 110 stacked in a first direction D1, and one or more pad members 120 provided between the plurality of battery cells 110. As described below, the battery cell 110 may be a pouch-type secondary battery. In addition, for example, the battery stack 100 may have a structure in which the two battery cells 110 and one pad member 120 are alternately stacked. The pad member 120 may be configured to press the battery cells 110 so that predetermined surface pressure is applied to the battery cells 110 in the battery stack 100.

In addition, the battery module 10 may further include heat transfer members 200 provided at one side of the battery stack 100 and provided to be in contact with the battery stack 100. The heat transfer member 200 may be configured to receive heat generated in the battery stack 100, such as the battery cell 110, and dissipate the heat to the outside. To this end, the heat transfer member 200 may contain or be made of (e.g., provided in the form of) a material with excellent thermal conductivity.

The plurality of battery cells 110 may each extend in a second direction D2 intersecting the first direction D1. For example, the first direction D1 and the second direction D2 may be horizontal directions.

In this case, the heat transfer member 200 may be provided at one side of the battery stack 100 in a third direction D3 intersecting the first and second directions D1 and D2. For example, the third direction D3 may be a vertical direction. In an example embodiment, the first direction D1 may be a thickness direction of the battery cell 110, and the second and third directions D2 and D3 may be longitudinal directions in which the battery cell 110 extends. In an example embodiment, the first direction D1, the second direction D2, and the third direction D3 may perpendicularly intersect one another.

The heat transfer members 200 according to the present disclosure may include a plurality of components made of different materials. For example, the heat transfer members 200 may include first and second heat transfer members 210 and 220 made of different materials.

The first and second heat transfer members 210 and 220 may (e.g., each) contain or be made of a curable material. Therefore, according to the present disclosure, the heat transfer member 200 may be formed by applying a material having fluidity onto one side of the battery stack 100 and then curing the material. In this case, according to the present disclosure, the fluidity of the first heat transfer member 210 measured before the first heat transfer member 210 is cured may be lower than the fluidity of the second heat transfer member 220 measured before the second heat transfer member 220 is cured.

According to the present disclosure, the first heat transfer member 210 may be configured to prevent the second heat transfer member 220 from spreading to an undesired region because of the fluidity of the second heat transfer member 220 during a process of curing the second heat transfer member 220 after the second heat transfer member 220 is applied. That is, the first heat transfer member 210 may serve to receive heat generated in the battery cell 110 and discharge the heat to the outside, and also serve to regulate a position to which the second heat transfer member 220 is applied.

The first heat transfer members 210 may be applied in peripheral regions of the second heat transfer member 220. For example, the first heat transfer member 210 may be applied in the peripheral region at one side of the second heat transfer member 220 in the second direction D2. For example, FIGS. 1 to 4 (e.g., respectively) illustrate states in which the first heat transfer members 210 are applied to the peripheral regions at one side and the other side of the second heat transfer member 220 in the second direction D2. This configuration may be understood as a configuration in which the first heat transfer members 210 in the two regions may be provided to face each other with the second heat transfer member 220 interposed therebetween. In this case, it may be possible to (e.g., substantially) prevent the second heat transfer member 220 from spreading in the second direction D2 during the process of applying and curing the second heat transfer member 220.

With continued reference to FIGS. 1 to 4, a maximum length of the first heat transfer member 210 in the first direction D1 may be shorter than a maximum length of the second heat transfer member 220 in the first direction D1. This configuration may be understood as a configuration in which some of the materials of the second heat transfer member 220 partially spread in the first direction D1 during the process of applying and curing the second heat transfer member 220. However, even in this case, as described below, according to the present disclosure, the second heat transfer member 220 may be (e.g., substantially) prevented from spreading to the entire region in the first direction D1.

In the battery module 10 according to the present disclosure, the heat transfer members 200 may be provided at two opposite sides of the battery stack 100 in the third direction D3. This configuration may be understood as a configuration in which the heat transfer members are respectively provided in upper and lower regions of the battery module 10.

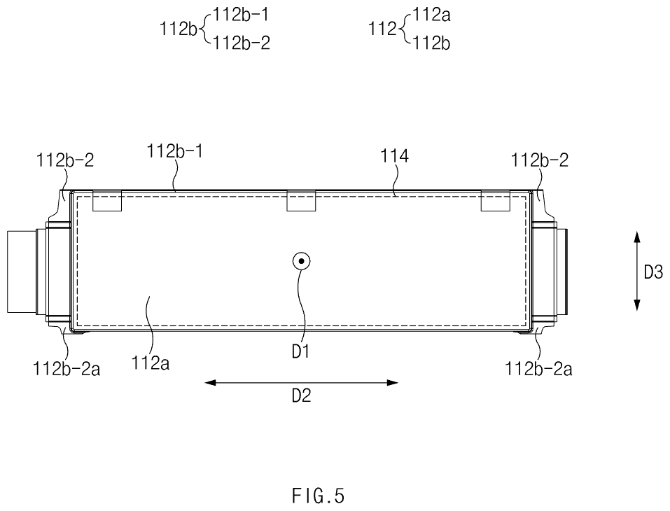

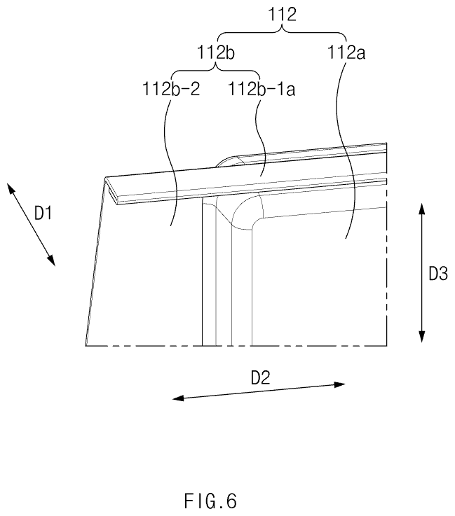

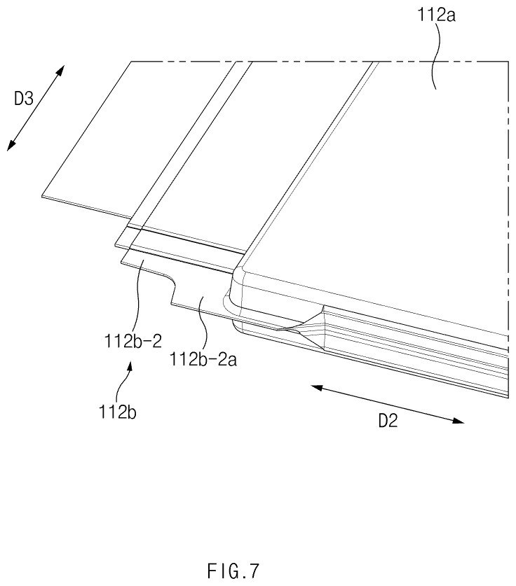

FIG. 5 is a side view of the battery cell provided in the battery module according to the present disclosure, and FIG. 6 is an enlarged view illustrating a bent section formed in a first sealing region of the battery cell in FIG. 5. FIG. 7 is an enlarged view illustrating a bat ear section formed in a second sealing region of the battery cell in FIG. 5.

With reference to FIG. 5, the plurality of battery cells 110 provided in the battery stack 100 according to the present disclosure may each include a pouch-type exterior material 112 having an internal space, and an electrode stack 114 accommodated in the internal space. That is, according to the present disclosure, the battery cell 110 may be a pouch-type secondary battery. The electrode stack 114 has a structure in which electrodes and separators are alternately stacked. The electrode stack 114 may be an electrode stack as used in the field of secondary batteries, thus a detailed description of the electrode stack may be omitted.

The above-mentioned pouch-type exterior material 112 may be divided into a plurality of regions. For example, the pouch-type exterior material 112 may include a pouch body region 112a configured to provide (e.g., define) the internal space, and a sealing region 112b formed by coupling (e.g., attaching) partial regions of the pouch-type exterior material 112 (e.g., provided) to surround a periphery of the pouch body region 112a. The sealing region 112b may be configured to seal the internal space from the outside.

The sealing region 112b may include a first sealing region 112b-1 formed at one side of the pouch-type exterior material 112 in the third direction D3. The first sealing region 112b-1 may be provided to be in contact with the heat transfer member 200. For example, the first sealing region 112b-1 may be provided (e.g., only) at one side of the pouch-type exterior material 112 in the third direction D3 without being provided at the other side of the pouch-type exterior material 112 in the third direction D3. In FIG. 5, the first sealing region 112b-1 may be formed in an upper peripheral region of the pouch-type exterior material 112. For example, the first sealing region 112b-1 may be provided to be in contact with the first heat transfer members 210 and the second heat transfer member 220.

With continued reference to FIGS. 5 to 7, the sealing region 112b may further include second sealing regions 112b-2 connected to one side end of the first sealing region 112b-1 in the second direction D2 and protruding in the second direction D2. The sealing region 112b may have an approximately “U” shape that surrounds the peripheral region of the pouch body region 112a. In this case, the second sealing regions 112b-2 may be respectively provided at two opposite side ends of the first sealing region 112b-1 in the second direction D2.

According to the present disclosure, bat ear sections 112b-2a may be provided at one side end of the second sealing region 112b-2 in a direction of the third direction D3 away from the first sealing region 112b-1, and the bat ear sections 112b-2a may protrude outward from the pouch body region 112a in the third direction D3. The bat ear section 112b-2a may be a region formed during a process of forming the pouch-type exterior material 112 having the internal space formed by joining partial regions of a pouch-type sheet. For example, the pouch-type exterior material 112 may be formed by forming a recessed region by forming the partial regions of the pouch-type sheet and then attaching peripheral regions of the recessed region. In this case, the bat ear section 112b-2a may be a section geometrically created because a thickness of the regions (i.e., the sealing regions) of the pouch-type exterior material 112, which are joined to each other, is relatively small, whereas a thickness of the region (i.e., the pouch body region) of the pouch-type exterior material 112, which defines the internal space, is relatively large.

In this case, according to the present disclosure, the heat transfer member 200 may be in contact with one side surface of the pouch body region 112a in the third direction D3 and provided inward of the bat ear sections 112b-2a in the second direction D2. This may be to prevent the bat ear section 112b-2a from being damaged by contact with the heat transfer member 200. For example, the heat transfer member 200 may be provided to overlap the bat ear sections 112b-2a in the third direction D3 and provided to be spaced apart inward from the bat ear sections 112b-2a in the second direction D2. The bat ear section 112b-2a may be disposed in a lower region of the battery cell 110 in FIG. 5. The heat transfer member 200, which overlaps the bat ear section 112b-2a in the third direction D3, may be a lower heat transfer member to be described below.

With continued reference to FIGS. 5 and 6, the first sealing region 112b-1 may have a bent shape. For example, a bent section 112b-1a may be formed in the first sealing region 112b-1 and bent in a direction intersecting the third direction D3. For example, the bent section 112b-1a may have a shape bent in the first direction D1.

The bent section 112b-1a may be in contact with the above-mentioned heat transfer member 200. In this case, the first sealing region 112b-1 and the heat transfer member 200 may be in surface contact with each other, such that the heat generated from the battery cell 110 may be more effectively dissipated. The heat transfer member, which faces the bent section 112b-1a or the first sealing region 112b-1, may be an upper heat transfer member to be described below.

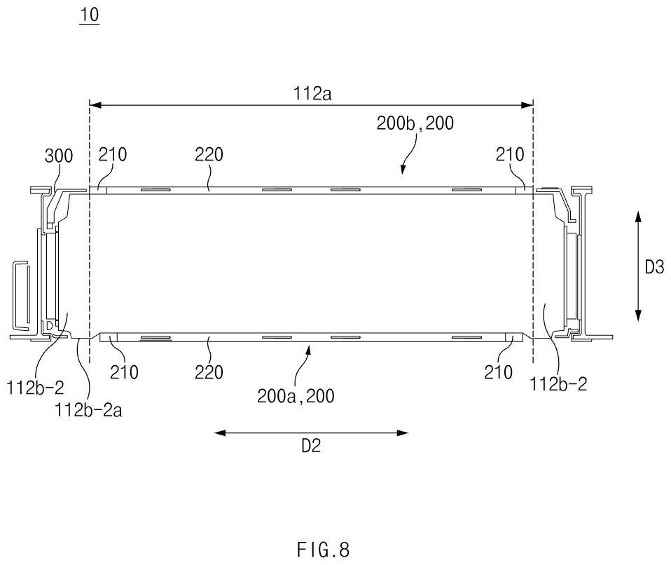

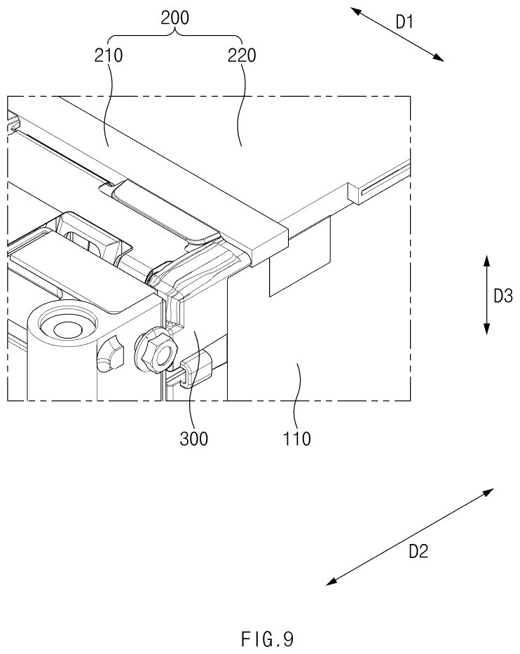

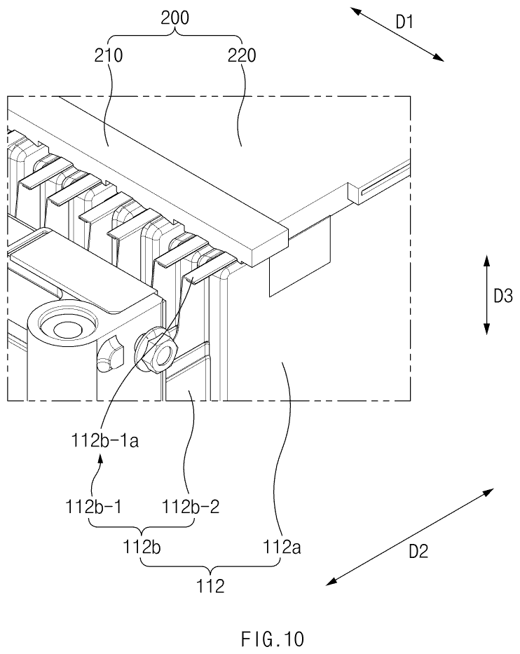

FIG. 8 is a vertical cross-sectional view of the battery module according to the present disclosure, and FIG. 9 is an enlarged view illustrating a holder member of the battery module according to the present disclosure and surrounding components thereof. FIG. 10 is a view illustrating a state in which the holder member in FIG. 9 is removed.

As illustrated in FIGS. 8 to 10, the battery module 10 according to the present disclosure may further include a holder member 300 provided at one side of the battery stack 100 in the second direction D2, and a busbar (not illustrated) assembled to the holder member 300 and electrically connected to the battery stack 100. The busbar may be configured to mediate electrical connection between the battery module 10 and external components. For example, the battery cell 110 may have a lead region protruding outward, tightly attached to the busbar, and electrically connected to the busbar. More particularly, the lead region may include a first section protruding in the second direction D2 while penetrating the busbar, and a second section bent from the first section in the first direction D1 and tightly attached to an outer surface of the busbar in the second direction D2. For example, the lead region may be provided at an end of each of the plurality of battery cells 110 in the second direction D2.

As illustrated in FIGS. 8 and 9, a partial region of the holder member 300 may be provided to cover one side of the battery stack 100 in the third direction D3. This configuration may be understood as a configuration in which in case that the third direction D3 is the vertical direction, one region of the holder member 300 may be provided in an upper region of the battery stack 100, and the other region of the holder member 300 may be provided in a lower region of the battery stack 100.

In this case, according to the present disclosure, the heat transfer member 200 may be provided to face, in the second direction D2, the portion of the holder member 300 that covers one side of the battery stack 100 in the third direction D3. In this case, the region of the holder member 300, which covers one side of the battery stack 100 in the third direction D3, may regulate a position of the heat transfer member 200 in the second direction D2.

With reference back to FIGS. 3 and 4, the pad members 120 may be provided as a plurality of pad members 120 provided in the battery stack 100. In this case, in case that a pad member, which is provided at an outermost side in the first direction D1 among the plurality of pad members 120 provided in the battery stack, is defined as an outermost side pad member 120a, a maximum length of the outermost side pad member 120a in the third direction D3 may be longer than a maximum length in the third direction D3 of another pad member 120 adjacent to the outermost side pad member 120a. For example, the maximum length of the outermost side pad member 120a in the third direction D3 may be longer than maximum lengths in the third direction D3 of the other pad members 120a excluding the outermost side pad member. In this case, the outermost side pad member 120a may further protrude in the third direction D3 than another pad member 120. In this case, it is possible to (e.g., substantially) prevent the heat transfer member 200 from spreading to the outside of the battery stack 100 in the third direction D3 during the process of curing the material of the heat transfer member 200 after the material of the heat transfer member 200 is applied. FIGS. 3 to 5 illustrate states in which the outermost side pad member 120a further protrudes than another pad member 120 in a direction of the third direction D3 in which the pouch body region 112a faces the first sealing region 112b-1 (i.e., the upward direction).

With continued reference to FIGS. 3 and 4, the battery module 10 according to the present disclosure may further include side plates 400 respectively provided at two opposite sides of the battery stack 100 in the first direction D1, and strip members 500 each having one side coupled to the side plate 400 provided at one of the two opposite sides of the battery stack 100, and the other side coupled to the side plate 400 provided at the other of the two opposite sides of the battery stack 100. The strip member 500 may be configured to apply surface pressure to the battery stack 100 together with the side plate 400.

The strip member 500 and the side plate 400 may contain or be made of the (e.g., substantially) same metallic material. The strip member 500 and the side plate 400 may be coupled (e.g., to each other) by welding. When the strip member 500 and the side plate 400 contain the same metallic material, the welding may be smoothly performed. For example, the strip member 500 and the side plate 400 may contain or be made of aluminum metal.

In addition, as illustrated in FIGS. 3 and 4, the above-mentioned outermost side pad member 120a may include a pad recess region 120a-1 formed at one side end of the outermost side pad member 120a in the third direction D3 and having a shape recessed in the third direction D3. For example, with reference to FIGS. 3 to 5, the pad recess region 120a-1 may be formed at one of the two opposite side ends of the outermost side pad member 120a in a direction of the third direction D3 in which the pouch body region 112a faces the first sealing region 112b-1. In this case, the strip member 500 may be seated in the pad recess region 120a-1.

When the battery module 10 has the strip member 500, the heat transfer member 200 may be provided to face the battery stack 100 in the third direction D3 with the strip member 500 interposed therebetween. In this case, the region of the second heat transfer member 220, which overlaps the strip member 500 in the first direction D1 and the second direction D2, may protrude further outward in the first direction D1 than the region of the second heat transfer member 220 spaced apart from the strip member 500 in the second direction D2 (i.e., the region that does not overlap the strip member). This configuration may be understood as being provided because a part of the material may leak outward along the strip member 500 seated in the pad recess region 120a-1 of the outermost peripheral pad member 120a during the process of applying and curing the material of the second heat transfer member 220. In contrast, because the region of the outermost peripheral pad member 120a, which excludes the region in which the pad recess region 120a-1 is formed, protrudes outward in the third direction D3, the section, through which the material of the second heat transfer member leaks outward, may be restricted.

Hereinafter, the battery pack according to the present disclosure will be described with reference to the drawings and the above-mentioned contents.

### Battery Pack

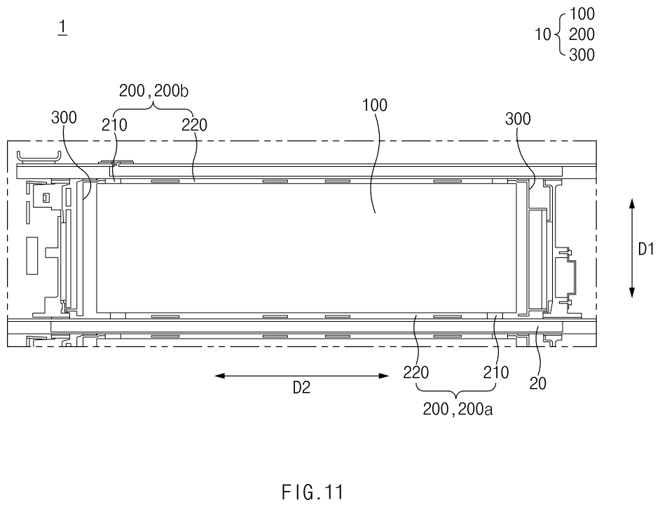

FIG. 11 is a cross-sectional view illustrating the battery pack according to the present disclosure.

With reference to FIG. 11, a battery pack 1 according to the present disclosure may include the battery module 10, and a cooling pipe 20 provided at one side of the battery module 10 in the third direction D3. The cooling pipe 20 may have a flow path through which a cooling fluid flows. The description of the battery module 10 provided in the battery pack according to the present disclosure is provided in the above-mentioned description. In the battery pack 1 according to the present disclosure, the third direction D3 may be the vertical direction. FIG. 11 illustrates a state in which the cooling pipe 20 is provided on a lower portion of the battery module 10. However, in example embodiments, the cooling pipe 20 may be provided on an upper portion of the battery module 10. For example, the battery pack 1 according to the present disclosure may have a structure in which the battery modules 10 and the cooling pipes 20 are alternately disposed in the vertical direction.

The heat transfer members 200 provided on the battery module 10 of the battery pack 1 according to the present disclosure may include a lower heat transfer member 200a provided in a lower region of the battery module 10 and provided between the battery stack 100 and the cooling pipe 20, and an upper heat transfer member 200b provided in an upper region of the battery module 10 and provided to face the lower heat transfer member 200a with the battery stack 100 interposed therebetween. The lower heat transfer member 200a and the upper heat transfer member 200b may respectively correspond to the heat transfer members 200 provided at the two opposite sides of the battery stack 100 in the third direction D3.

According to the present disclosure, the upper heat transfer member 200b may be (e.g., fixedly) coupled to the battery stack 100, and the lower heat transfer member 200a may be (e.g., fixedly) coupled to the cooling pipe 20. For example, during the process of manufacturing the battery pack 1 according to the present disclosure, the lower heat transfer member 200a may be fixed to the cooling pipe 20 by i) applying or attaching the first heat transfer members 210 to the two opposite sides of the upper surface of the cooling pipe 20 in the second direction D2, ii) applying the second heat transfer member 220 to the internal space defined by the first heat transfer member 210, and then iii) curing the first heat transfer member 210 and the second heat transfer member 220. In addition, during the process of manufacturing the battery pack 1 according to the present disclosure, the upper heat transfer member 200b may be fixed to the battery stack 100 by i) applying or attaching the first heat transfer members 210 to the two opposite sides of the upper surface of the battery stack 100 in the second direction D2, ii) applying the second heat transfer member 220 to the internal space defined by the first heat transfer member 210, and then iii) curing the first heat transfer member 210 and the second heat transfer member 220. Therefore, in the battery pack 1 according to the present disclosure, the battery stack 100 and the lower heat transfer member 200a may be tightly attached to each other without being fixed to each other. However, alternatively, the battery stack 100 and the lower heat transfer member 200a may be fixed to each other.

As described above, the lower heat transfer member 200a and the upper heat transfer member 200b may each include the first heat transfer member 210 and the second heat transfer member 220. In this case, as illustrated in FIG. 11, a width and a position in the first direction D1 and the second direction D2 of the first heat transfer member 210 of the upper heat transfer member 200b may correspond to a width and a position in the first direction D1 and the second direction D2 of the first heat transfer member 210 of the lower heat transfer member 200a, and a width and a position in the first direction D1 and the second direction D2 of the second heat transfer member 220 of the upper heat transfer member 200b may correspond to a width and a position in the first direction D1 and the second direction D2 of the second heat transfer member 220 of the lower heat transfer member 200a. This configuration may be understood as a configuration in which the upper heat transfer member 200b and the lower heat transfer member 200a may have substantially the same size and shape and also (e.g., entirely) overlap (e.g., each other) when the battery pack 1 is viewed from a location spaced apart from the battery pack 1 in the third direction D3.

The present disclosure has been described with reference to the limited embodiments and the drawings, but the present disclosure is not limited thereby. The present disclosure may be carried out in various forms within the technical spirit of the present disclosure and the appended claims.

What is claimed is:

1. A battery module comprising:
a battery stack comprising a plurality of battery cells stacked in a first direction, and at least one pad member provided between the plurality of battery cells; and
a heat transfer member provided at a side of the battery stack and provided to be in contact with the battery stack,
wherein the plurality of battery cells extend in a second direction, the second direction intersects the first direction,
wherein the heat transfer member is provided in a third direction, the third direction intersects the first direction and the second direction, and
wherein the heat transfer member includes a first heat transfer member and a second heat transfer member, the first heat transfer member and the second heat transfer member are provided in the form of different materials.

2. The battery module of claim 1, wherein the first heat transfer member and the second heat transfer member contain a curable material.

3. The battery module of claim 2, wherein fluidity of the first heat transfer member measured before the first heat transfer member is cured is lower than fluidity of the second heat transfer member measured before the second heat transfer member is cured.

4. The battery module of claim 1, wherein the first heat transfer member is applied to a peripheral region of the second heat transfer member.

5. The battery module of claim 4, wherein the first heat transfer member is applied to a peripheral region at a side of the second heat transfer member in the second direction.

6. The battery module of claim 5, wherein a length of the first heat transfer member in the first direction is shorter than a length of the second heat transfer member in the first direction.

7. The battery module of claim 1, wherein the first heat transfer member is provided on opposite sides of the battery stack in the third direction.

8. The battery module of claim 1, wherein each of the plurality of battery cells include:
a pouch-type exterior material having an internal space; and
an electrode stack accommodated in the internal space,
wherein the pouch-type exterior material includes
a pouch body region configured to provide the internal space, and
a sealing region formed by attaching partial regions of the pouch-type exterior material to surround a periphery of the pouch body region,
wherein the sealing region includes a first sealing region formed at one side of the pouch-type exterior material in the third direction and
wherein the first sealing region is provided to be in contact with the heat transfer member.

9. The battery module of claim 8, wherein the first sealing region is configured to contact the first heat transfer member and the second heat transfer member.

10. The battery module of claim 8, wherein the sealing region further includes second sealing regions connected to one side end of the first sealing region in the second direction and protruding in the second direction and
wherein a bat ear section, which protrudes from the pouch body region in the third direction, is provided at one side end of the second sealing region in a direction of the third direction away from the first sealing region.

11. The battery module of claim 10, wherein the second sealing regions are provided at opposite side ends of the first sealing region in the second direction, and
wherein the heat transfer member is in contact with one side surface of the pouch body region in the third direction and provided inward of the bat ear section in the second direction.

12. The battery module of claim 8, wherein the first sealing region has a bent section bent in a direction intersecting the third direction, and the bent section is in contact with the heat transfer member.

13. The battery module of claim 1, further including:
a holder member provided at one side of the battery stack in the second direction,
wherein a partial region of the holder member is provided to cover one side of the battery stack in the third direction and
wherein the heat transfer member is provided to face, in the second direction, a portion of the holder member that covers one side of the battery stack in the third direction.

14. The battery module of claim 1, wherein a maximum length in the third direction of an outermost side pad member, which is provided at an outermost side in the first direction provided in the battery stack, is longer than a maximum length in the third direction of another pad member adjacent to the outermost side pad member.

15. The battery module of claim 14, further comprising:
side plates provided at two opposite sides of the battery stack in the first direction; and
a strip member having a side coupled to the side plate provided at one side of the battery stack, and another side of the strip member is coupled to the side plate provided at the other side of the battery stack,
wherein the outermost side pad member includes a pad recess region formed at one side end of the outermost side pad member in the third direction and having a shape recessed in the third direction and
wherein the strip member is seated in the pad recess region.

16. The battery module of claim 15, wherein the heat transfer member is provided to face the battery stack in the third direction with the strip member interposed therebetween and
wherein a region of the second heat transfer member, which overlaps the strip member, further protrudes outward in the first direction than a region of the second heat transfer member spaced apart from the strip member in the second direction.

17. A battery pack comprising:
a battery module including
a battery stack comprising a plurality of battery cells stacked in a first direction, and at least one pad member provided between the plurality of battery cells, and
a heat transfer member provided at a side of the battery stack and provided to be in contact with the battery stack,
wherein the plurality of battery cells extend in a second direction, the second direction intersects the first direction,
wherein the heat transfer member is provided in a third direction, the third direction intersects the first direction and the second direction, and
wherein the heat transfer member includes a first heat transfer member and a second heat transfer member, the first heat transfer member and the second heat transfer member are provided in the form of different materials; and
a cooling pipe provided at a side of the battery module in the third direction,
wherein the heat transfer member includes
a lower heat transfer member provided between the battery stack and the cooling pipe, and
an upper heat transfer member provided to face the lower heat transfer member with the battery stack interposed therebetween.

18. The battery pack of claim 17, wherein the upper heat transfer member is fixedly coupled to the battery stack.

19. The battery pack of claim 18, wherein the lower heat transfer member is fixedly coupled to the cooling pipe.

20. The battery pack of claim 17, wherein each of the lower heat transfer member and the upper heat transfer member includes the first heat transfer member and the second heat transfer member,
wherein a width and a position in the first direction and the second direction of the first heat transfer member of the upper heat transfer member correspond to a width and a position in the first direction and the second direction of the first heat transfer member of the lower heat transfer member, and
wherein a width and a position in the first direction and the second direction of the second heat transfer member of the upper heat transfer member correspond to a width and a position in the first direction and the second direction of the second heat transfer member of the lower heat transfer member.
